(19) United States
(12) Patent Application Publication
(10) Pub. No.: US 2026/0192233 A1
(43) Pub. Date: Jul. 9, 2026

(54) FILTER ELEMENT HAVING TWO FILTER MEDIUM BODIES ARRANGED ONE INSIDE THE OTHER

(71) Applicant: MANN+HUMMEL GmbH, Ludwigsburg (DE)

(72) Inventors: Pascal NEEF, Trossingen (DE); Christoph WITTMERS, Bietigheim-Bissingen (DE); Andreas WEBER, Freiberg (DE); Dennis STARK, Mauer (DE); Mario RIEGER, Ludwigsburg (DE); Markus HANSELMANN, Lauffen (DE); Peter PEKNY, Neuenmarkt (DE); Eva HALLBAUER, Himmelkron (DE); Daniel SCHMID, Sachsenheim (DE); Steffen GERLACH, Nufringen (DE); Friedrich KUPFER, Marklkofen (DE); Philipp HETTKAMP, Steinheim (DE); Johannes GRAD, Simbach (DE); Pedro Miguel PEREIRA MADEIRA, Bietigheim-Bissingen (DE); Dieter WEISS, Gefrees (DE); Fritz BRENNEIS, Marklkofen (DE); Reinhard SUESS, Marklkofen (DE); Joachim-Paul KRIEGER, Reisbach (DE); Klaus GEHWOLF, Mamming (DE)

(21) Appl. No.: 19/553,875

(22) Filed: Mar. 2, 2026

Related U.S. Application Data
(63) Continuation of application No. PCT/EP2024/072807, filed on Aug. 13, 2024.

(30) Foreign Application Priority Data
Sep. 7, 2023 (DE) 10 2023 124 179.6

(51) Int. Cl. B01D 46/64; B01D 46/00; B01D 46/24; B01D 46/52; B01D 53/04; H01M 8/0662

(52) U.S. Cl. CPC B01D 46/64; B01D 46/0036; B01D 46/2414; B01D 46/521; B01D 53/0415; H01M 8/0687; B01D 2253/102; B01D 2271/027; B01D 2275/208

(57) ABSTRACT

A filter element has first and second filter medium bodies, wherein one of the first and second filter medium bodies is arranged inside of the other one of the first and second filter medium bodies, and wherein the filter medium bodies are flowed through sequentially. An end plate is arranged at an end face of the filter element. At least the second filter medium body has a folded filter medium with end face edges at the end face. A side band seals the end face edges of the folded filter medium of the second filter medium body at the end face. The side band is embedded at least partially in the end plate. The filter element may be a cathode air filter of a fuel cell with an anode, a cathode, and electrolyte between the anode and the cathode, and the filter element configured to guide air to the cathode.

### CROSS-REFERENCE TO RELATED APPLICATIONS

This application is a continuation application of international application No. PCT/EP2024/072807 having an international filing date of Aug. 13, 2024, and designating the United States, the international application claiming a priority date of Sep. 7, 2023, based on prior filed German patent application No. 10 2023 124 179.6, the entire contents of the aforesaid applications being incorporated herein by reference to the fullest extent permissible.

### BACKGROUND

The invention concerns a filter element with a first and a second annular filter medium body, wherein one of the filter medium bodies is arranged inside of the other filter medium body and wherein the two filter medium bodies may be flowed through sequentially, wherein the filter element includes an end plate at one end face, and wherein at least the second filter medium body includes a folded filter medium.

Such a filter element is disclosed in WO 2015/092681 A1.

In various applications, it may be necessary to guide a fluid to be filtered, for example gas, sequentially through two different filter media in order to remove all troublesome components from the fluid. For a space-saving configuration, two annular filter medium bodies may be employed, wherein one of the filter medium bodies is arranged in the interior of the other filter medium body.

In order to retain harmful gases, adsorbing filter media are known. For example, active carbon may be contained in the filter medium. Such a filter medium may contain, for example, active carbon particles which are enclosed between two layers of filter paper. When processing such filter media, there is then the risk that active carbon particles escape from the open edges of the filter medium. Also, when using such filter media, one must pay attention that no active carbon particles reach the clean side. In addition, such filter media include only a comparatively minimal inherent stiffness which makes handling in manufacture and assembly difficult.

For a serial flow through two filter medium bodies, they must be sealed relative to each other or a filter housing in a suitable manner.

The above already mentioned WO 2015/092681 A1 describes a filter element with two layers of filter material of folded paper which includes a cylindrical shape. The two layers of filter material are held non-detachably at each other in that they are embedded in sections in seals of plastic material. The seals may be arranged in the manner of end plates at both end faces of the filter element.

It is an object of the invention to provide a filter element with two filter medium bodies sealed relative to each other and configured to be flowed through serially, which filter element may be produced economically and mounted easily, for example wherein an escape of adsorbing particles during the manufacture of the filter element and its operation is avoided.

### SUMMARY

This object is solved by a filter element, for example gas filter element, including a first and a second filter medium body, wherein one of the filter medium bodies is arranged inside of the other filter medium body and wherein the two filter medium bodies may be flowed through sequentially, wherein the filter element includes an end plate at an end face, wherein at least the second filter medium body includes a folded filter medium, wherein end face edges of the folded filter medium of the second filter medium body are sealed at the end face by a side band, and wherein the side band is embedded at least partially in the end plate.

The object is further solved by a use of a filter element according to the invention as cathode air filter of a fuel cell.

The object is further solved by a fuel cell including an anode and a cathode between which an electrolyte is arranged and including a filter element according to the invention, through which air may be guided to the cathode.

Embodiments of the invention are disclosed in the following description and the accompanying drawings.

According to the invention, a filter element with a first and a second annular filter medium body is provided. The filter element is for example a gas filter element. Typically, both filter medium bodies enclose an interior in circumferential direction. One of the filter medium bodies is arranged inside of the other filter medium body. One (the inner) filter medium body is thus received in the interior of the other (the outer) filter medium body. The two filter medium bodies may be flowed through sequentially.

The filter element may be round or oval in cross section; this applies correspondingly to the two filter medium bodies. In principle, the two filter medium bodies surround together a longitudinal axis of the filter element which extends through the interior of the inner filter medium body and thus also the interior of the outer filter medium body. The longitudinal axis may be a symmetry axis of the filter element or may lie in a symmetry plane of the filter element. The filter element is, however, not necessarily symmetrical in relation to an axis or plane. In the context of describing the present invention, directional specifications such as, for example, radial or axial, relate to the longitudinal axis, inasmuch as nothing to the contrary is indicated.

Typically, the second filter medium body may be flowed through after the first filter medium body. The filter element may be flowed through in radial direction from the interior to the exterior or from the exterior to the interior.

The filter element includes at a (first, axial) end face a (first) end plate. The end plate participates in sealing the two filter medium bodies relative to each other. In addition, the end plate may seal the first filter medium body at the end face. The first filter medium body may be embedded in the end plate. The end plate may be of or include an injectable or castable material, for example, the end plate may be of or include a polyurethane foam. The end plate may be closed. As an alternative, the end plate may include a central opening through which fluid to be filtered may flow into the interior of the filter element or filtered fluid may flow out of the interior. In embodiments, the side band may be embedded at least partially in an injectable or castable material of the end plate.

The first filter medium body may include a folded filter medium. The first filter medium body may be obtained from a filter medium for particle filtration. The first filter medium body may be manufactured with cellulose-containing or synthetic filter paper.

The second filter medium body includes a folded filter medium. The second filter medium body may contain an adsorption medium. The folded filter medium of the second filter medium body may contain active carbon, for example, active carbon particles may be enclosed between two layers of filter paper. Such filter media are particularly effective in order to retain harmful gases.

According to the invention, end face edges of the folded filter medium of the second filter medium body are sealed at the (first) end face by a (first) side band. The side band is typically connected permanently to the filter medium so that it cannot be detached from the filter medium of the second filter medium body without causing destruction. For example, the side band may be glued at the end face edges to the second filter medium body. The side band is in general of a material whose gas permeability is less than that of the filter medium of the folded filter medium body. Depending on the installation situation, a larger gas permeability of the side band is also possible, however.

In embodiments, the side band may extend in a plane extending normal to the longitudinal axis. In embodiments, the side band may have a thickness which is a multiple times smaller, for example at least 5 times smaller, than an extension of the side band in radial direction.

The side band serves on the one hand for flow guidance at the second filter medium body in that it prevents that a gas flow bypasses unfiltered the second filter medium body. On the other hand, the side band simplifies handling of the second filter medium body once it has been connected thereto. For this, the side band may stiffen the second filter medium body. This simplifies, for example, the fixation of the two filter medium bodies at each other. In addition, the side band prevents that active carbon particles escape in case of a filter medium containing active carbon.

The side band may have a larger bending stiffness than the filter medium of the second filter medium body. In this way, the second filter medium body is stabilized particularly effectively.

The side band may contain a nonwoven material, for example a filter nonwoven, a fabric, for example a filter fabric, or a scrim, for example a filter scrim. These materials are inexpensively available and have suitable properties.

In embodiments, the side band may include an air-permeable material, for example a permeable nonwoven material. An air permeability of the nonwoven material of the side band may be for example less than an air permeability of the filter medium of the second filter medium body.

Further in accordance with the invention, the side band is embedded at least partially in the end plate. In this way, on the one hand, the two filter medium bodies are held at each other. Thus, an easily manageable filter element is created that combines the two filter medium bodies. On the other hand, the two filter medium bodies are sealed relative to each other by embedding the side band in the end plate. For this purpose, the side band is in principle embedded annularly circumferentially in the end plate. The sealing action of the two filter medium bodies relative to each other at the end face may also simplify the sealing action of the filter element in relation to a housing, for example when the end plate is an open end plate. For example, the end plate and the side band are arranged substantially at the same axial height. This reduces the material requirement for embedding.

The side band may protrude (project) in radial direction past the folded filter medium of the second filter medium body. For example, the side band may protrude toward the interior and/or toward the exterior. The projection of the side band may simplify its embedding in the end plate and may contribute to further reducing the material requirement for the end plate.

In an embodiment, only a (first) radial subregion of the side band is embedded in the end plate. For example, the side band may be embedded only with the radially protruding subregion in the end plate. In the remaining (second) radial subregion, the surface of the side band—facing away from the folded filter medium body—is then exposed. This configuration requires particularly little material for producing the end plate. The term “radial subregion” refers herein to a circumferential rim at an inner and/or outer circumference of the side band.

In an alternative embodiment, the side band is completely embedded in the end plate. This may be advantageous in respect to sealing of the filter element in relation to a housing. Also, in case the side band includes slots in order to facilitate manufacture of the annular shape, a complete embedding may be advantageous for reasons of flow guidance.

The second filter medium body with the side band may be arranged radially inside of the first filter medium body. In other words, the first filter medium body may surround the second filter medium body with the side band at the outer side. Flow through the filter element is realized in this arrangement typically from the exterior to the interior in radial direction.

Alternatively, the second filter medium body with the side band may surround the first filter medium body at the outer side. In other words, the first filter medium body may be arranged inside of the second filter medium body with the side band. Flow through the filter element is realized in this arrangement typically from the interior to the exterior in radial direction.

The second filter medium body may include at least one folded filter bellows whose head faces are sealed by head bands, wherein the annular shape of the second filter medium body is obtained by gluing two head bands to each other. This simplifies the manufacture of the second filter medium body. First, the second filter medium is folded in a zigzag shape so that a substantially rectangular filter bellows is obtained. Its head faces (parallel to the folding direction and in depth direction of the folds) are provided with the head bands, for example, in that they are glued on. Subsequently, the filter bellows is bent and fixed in the annular shape by gluing together head bands which are adjoining each other. Also, the side band is typically attached prior to the filter bellows being bent to the annular shape.

For example, the second filter medium body may be obtained from at least two filter bellows, wherein filter bellows adjoining each other in circumferential direction are glued to each other at their respective head bands. The second filter medium body is thus assembled of a plurality of filter bellows, wherein filter bellows adjoining each other in the annular shape are fixed to each other and sealed relative to each other by gluing the head bands to each other, respectively. In this way, large filter elements may be efficiently manufactured.

The filter element may taper in axial direction. This may simplify the attachment of a support body to the filter element. For example, the filter element may be conical.

The side band may include slots which extend into folds of the second filter medium body. The slots facilitate bringing the second filter medium body into the annular shape. The slots may begin at an outer edge or at an inner edge of the side band. In principle, the slots do not extend completely between the inner edge and the outer edge through the side band, but typically at most by four fifths, for example, at most three fourths, of the width of the side band.

It may be provided that at least in a subregion of the second filter medium body including at least five, for example at least ten, sequentially arranged folds open at a common circumferential side, particularly preferred about the entire circumference, a slot, for example precisely one slot, extends into each open fold of the subregion at the common circumferential side, respectively. In this way, the flexibility of the side ban may be particularly effectively increased, for example locally.

The filter element may include a second end plate at a second (axial) end face, wherein end face edges of the second filter medium body at the second end face are sealed by a second side band, and wherein the second side band is embedded at least partially in the second end plate. In this way, the two filter medium bodies may be sealed relative to each other and fixed at each other also at the second end face, in addition to the first end face. Embedding of the second side band in the second end plate may be realized as described above for the first side band and the first end plate. For example, the second side band and the second end plate may include further features described above in connection with the first side band and the first end plate. One of the end plates may be an open end plate and the other end plate a closed end plate.

In addition to the first side band, the second side band may also include slots which extend into the folds of the second filter medium body. It is provided that the slots in one of the side bands begin at its inner edge and that the slots at the other side band begin at its outer edge. By expanding the side band with slots at the outer side and compressing the side band with slots at the inner side, a tapering filter element may be obtained, wherein tensions or elongations in the side bands remain small.

A nonwoven cover is arranged at a circumferential surface of the second filter medium body which is facing away from the first filter medium body. The nonwoven cover prevents that active carbon particles, possibly adhering to the second filter medium body and originating from the production process prior to application of the side band, may reach the clean side.

At a circumferential surface of the second filter medium body which is facing away from the first filter medium body, a support body may be arranged. The support body stabilizes the filter element which is typically flowed through in the direction toward the support body. For this purpose, the second filter medium body may be supported indirectly or directly at the support body. In case a nonwoven cover is provided, it may be arranged between the second filter medium body and the support body. The support body may be a central support tube or an outer cage.

The scope of the present invention also encompasses a filter device, for example a gas filter device, including a housing and a filter element according to the invention described above which may be arranged in the housing so that a raw side is separated from a clean side.

The scope of the present invention also encompasses a use of a filter element according to the invention described above, for example of a filter device according to the invention described above as a cathode filter of a fuel cell.

The scope of the present invention encompasses finally a fuel cell with an anode and a cathode between which an electrolyte is arranged and with a filter element according to the invention described above through which air may be guided to the cathode.

Fuel cells often require a two-stage filtration of the air supplied to the cathode, for example wherein, in addition to particles, harmful gases are to be retained. The filter element according to the invention enables this due to its configuration described herein.

### BRIEF DESCRIPTION OF THE DRAWINGS

Further features and advantages of the invention result from the following detailed description of embodiments of the invention as well as based on the accompanying drawing figures showing details according to the invention. The aforementioned and still to be explained features may be realized individually by themselves or several thereof in any expedient combinations in variants of the invention. The features provided in the drawings are illustrated such that the particularities according to the invention may be made clearly visible.

FIG. 1 shows a first embodiment of a filter element according to the invention with a first filter medium body and a second filter medium body in a schematic section view.

FIG. 2 shows an enlarged detail of FIG. 1 in the region of a first end face.

FIG. 3 shows an enlarged detail of FIG. 1 in the region of a second end face.

FIG. 4 shows a second embodiment of a filter element according to the invention with a first filter medium body and a second filter medium body in a schematic section view.

FIG. 5 shows an enlarged detail of FIG. 4 in the region of a first end face.

FIG. 6 shows an enlarged detail of FIG. 4 in the region of a second end face.

FIG. 7 shows a filter device with the filter element of FIG. 4 in a schematic section view.

FIG. 8 shows a third embodiment of a filter element according to the invention with a first filter medium body and a second filter medium body in a schematic section view.

FIG. 9 shows the filter element of FIG. 8 in a further schematic section view, perpendicular to the section plane of FIG. 8.

FIG. 10 shows the second filter medium body of the filter element of FIG. 8 in a schematic perspective view at a slant from above.

FIG. 11 shows a bottom-side schematic view of the second filter medium body of FIG. 10.

FIG. 12 shows a schematic illustration of covering end face edges of the second filter medium body with a slotted side band.

FIG. 13 shows a filter device with the filter element of FIG. 8 in a schematic section view.

FIG. 14 shows a schematic section view of a folded filter medium containing active carbon.

FIG. 15 shows a schematic illustration of a fuel cell according to the invention with a filter element according to the invention as a cathode air filter.

### DETAILED DESCRIPTION

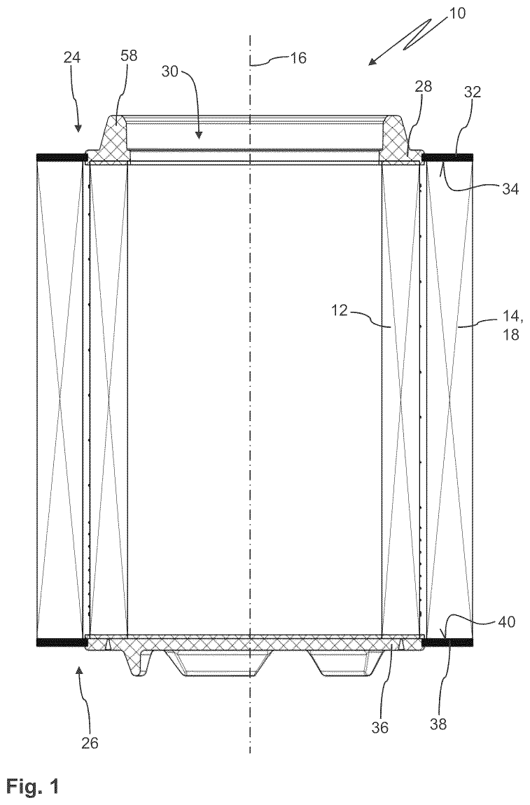

FIG. 1 shows a filter element 10 which is configured as an air filter element. The filter element 10 comprises two annular, here hollow cylindrical, filter medium bodies 12, 14. The first filter medium body 12 is arranged inside of the second filter medium body 14. The two filter medium bodies 12, 14 surround a common longitudinal axis 16. The filter element 10 or the two filter element bodies 12, 14 are connected serially in fluid communication. The second filter medium body 14 is downstream of the first filter medium body 12. The filter element 10 in this embodiment is flowed through in radial direction from the interior to the exterior.

The first filter medium body 12 comprises a filter medium for particle filtration. Here, the particle filtration medium is a filter paper folded in a star shape. As an alternative, the particle filtration medium could be a depth filtration medium.

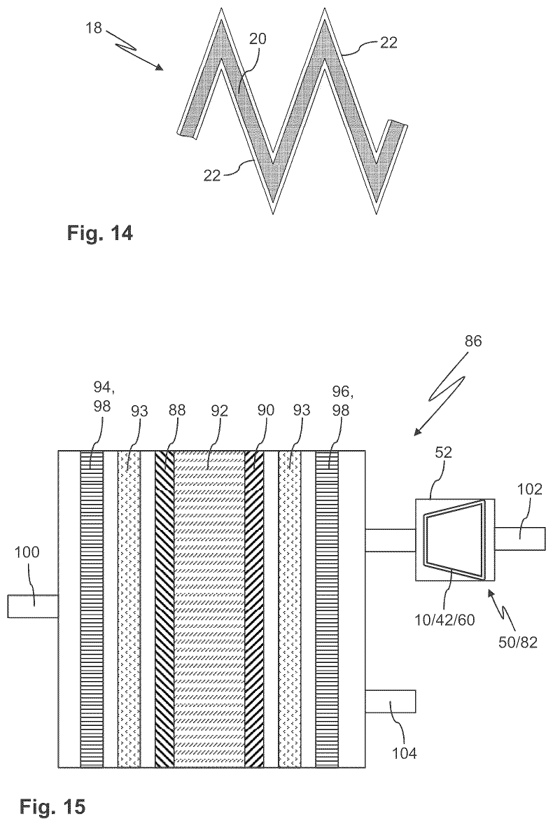

The second filter medium body 14 comprises a filter medium 18 in the form of an adsorption medium that here contains active carbon. The second filter medium body 14 serves for removal of harmful gases from the air flow to be filtered. The adsorbing filter medium 18 is folded in a star shape, compare FIG. 14. In FIG. 14, it may furthermore be seen that, in case of the adsorbing filter medium 18, a layer 20 containing active carbon particles is enclosed between two layers of filter paper 22.

At a first end face 24 and a second end face 26, the two filter medium bodies 12, 14 are connected to each other and sealed relative to each other; compare FIG. 1.

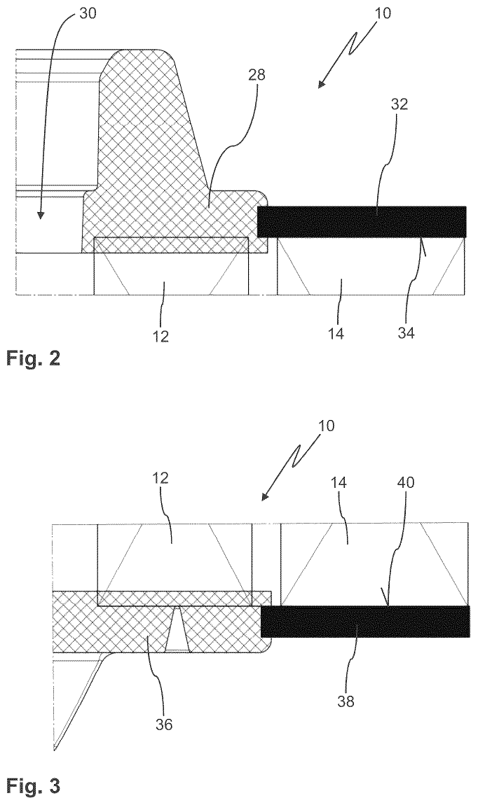

At the first end face 24, the first filter medium body 12 is framed by a first end plate 28, compare also FIG. 2. The first end plate 28 is an open end plate with a central opening 30 for entry of air to be filtered. The first end plate 28 may be comprised of polyurethane foam.

The second filter medium body 14 is framed at the first end face 24 by a first side band 32. The first side band 32 is glued to the first end face edges 34 of the filter medium 18. The second filter medium body 14 is thereby sealed at the first end face 24. In addition, the first side band 32 prevents escape of active carbon particles.

The first side band 32 protrudes in radial direction inwardly past the second filter medium body 14. The first side band 32 is embedded in the first end plate 28 only in the region of the projection. A subregion of the first side band 32 which is radially farther outwardly located is exposed (at the side which is facing away from the second filter medium body 14). The first end plate 28 may be injection molded to the first filter medium body 12 and the projecting subregion of the first side band 32.

At the second end face 26, the first filter medium body 12 is framed by a second end plate 36, compare FIG. 1 and FIG. 3. The second end plate 36 is a closed end plate. The second end plate 36 may be comprised of polyurethane foam.

The second filter medium body 14 is framed at the second end face 26 by a second side band 38. The second side band 38 is glued to the second end face edges 40 of the filter medium 18. The second filter medium body 14 is thereby sealed at the second end face 26. In addition, the second side band 38 prevents escape of active carbon particles.

The second side band 38 protrudes in radial direction inwardly past the second filter medium body 14. Only in the region of the projection, the second side band 38 is embedded in the second end plate 36. A subregion of the second side band 38 located radially father outwardly is exposed (at the side which is facing away from the second filter medium body 14). The second end plate 36 may be injection molded to the first filter medium body 12 and the projecting subregion of the second side band 38.

The first and the second side bands 32, 38 may be comprised of a nonwoven material.

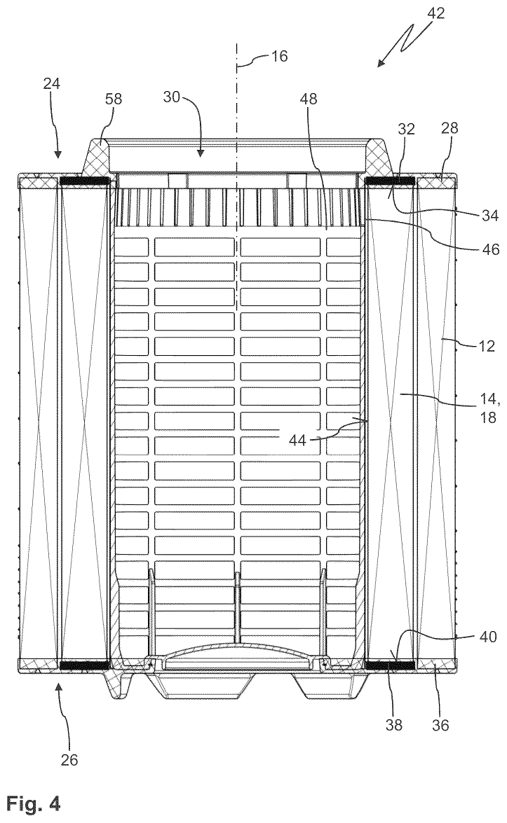

FIG. 4 shows a filter element 42 with two filter medium bodies 12, 14 which may be flowed through serially from the exterior to the interior in radial direction. In the filter element 42, the second filter medium body 14 is arranged inside of the first filter medium body 12.

The two filter medium bodies 12, 14 are embodied substantially as described above for the filter element 10; therefore, reference is being had to the above description. In the following, primarily the differences between the filter elements 10 and 42 are described.

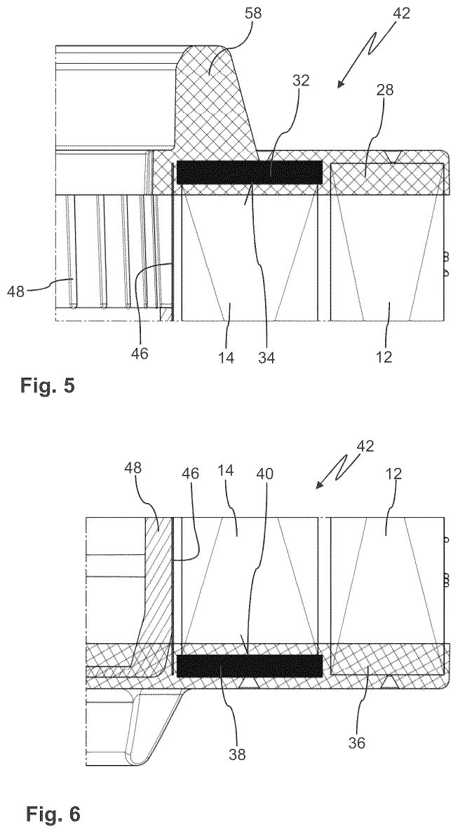

The second filter medium body 14 is provided at the first and second end faces 24, 26 with a first and a second side band 32, 38, respectively; compare also FIGS. 5 and 6. In addition, a first and a second end plate 28, 36 are provided at the first and second end faces 24, 26, respectively. The end plates 28, 36 may be comprised of polyurethane foam. The side bands 32, 38 are embedded here completely in the material of the first and second end plate 28, 36, respectively, compare also FIGS. 5 and 6. In other words, the end plates 28, 36 enclose the side bands 32 and 38 on all sides, respectively.

At a circumferential surface 44 facing away from the first filter medium body 12, here thus radially inwardly, a nonwoven cover 46 is arranged at the second filter medium body 14.

At the radially inner circumferential surface 44, a support body 48, here in the form of a grid-type support tube, is furthermore arranged. The nonwoven cover 46 in this context is received between the support body 48 and the second filter medium body 14. It is understood that the support body 48 could be present even in case that the nonwoven cover 46 should not be provided.

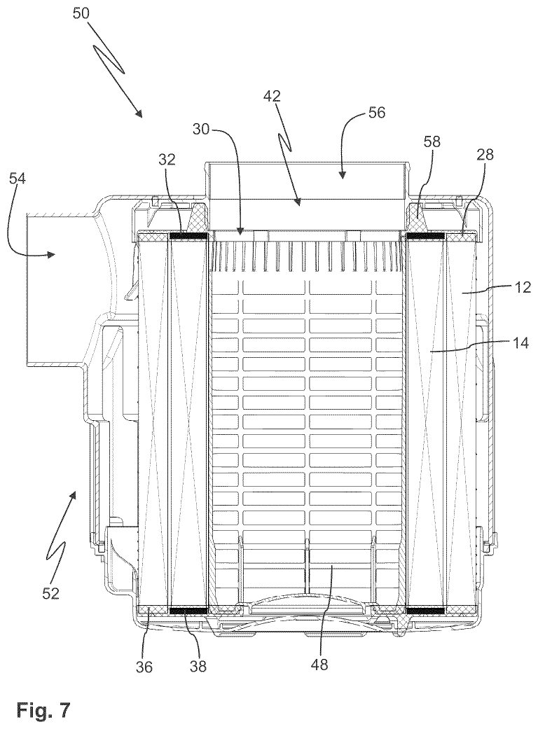

FIG. 7 shows a filter device 50 with the filter element 42 received in a housing 52. An inlet 54 enables entry of air to be filtered to the exterior side of the filter element 42. Filtered air may be discharged through an outlet 56 from the interior of the filter element 42.

The first end plate 28 is an open end plate with a central opening 30. The first end plate 28 comprises a seal bead 58 (compare also FIGS. 4 and 5) for sealing in relation to the housing 50. Here, the seal bead 58 surrounds the outlet 56.

At the second end face 26, the filter element 42 is closed, wherein the support body 48 closes off the second end plate 36 radially inwardly. In this way, an air flow coming from the inlet 54 is first guided through the first filter medium body 12 and subsequently through the second filter medium body 14 before the air flow exits the housing 50 at the outlet 56.

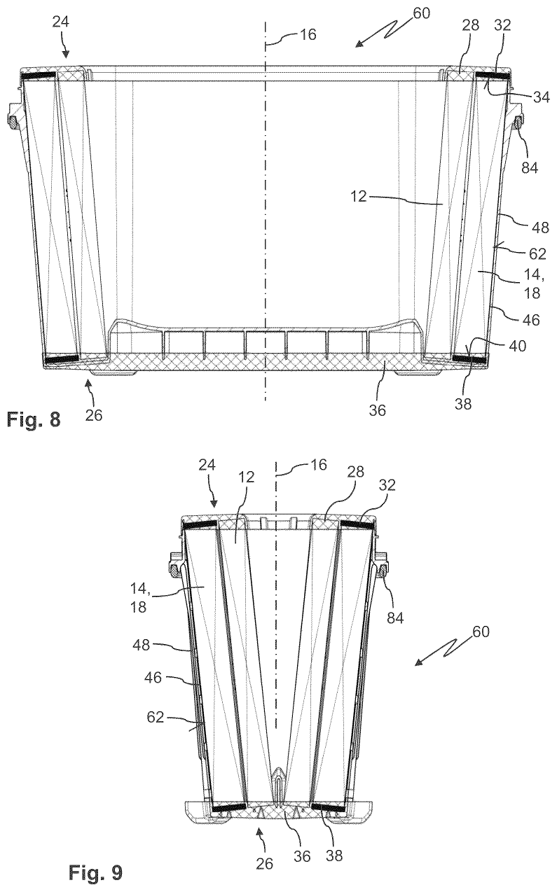

FIGS. 8 and 9 show a filter element 60 which comprises an oval cross section. The filter element 60 may be flowed through in radial direction from the interior to the exterior. A first filter medium body 12 is arranged inside of a second filter medium body 14. The first filter medium body 12 comprises a filter medium for particle filtration. The second filter medium body 14 comprises a folded filter medium 18 in the form of an adsorption medium which here contains active carbon. The filter element 60 and the two filter medium bodies taper along their common longitudinal axis 16 from a first end face 24 to a second end face 26.

At the first end face 24, an open first end plate 28 is arranged which frames the first filter medium body 12 as well as the second filter medium body 14. A first side band 32, which covers first end face edges 34 of the second filter medium body 14, is completely embedded in the first end plate 28.

At the second end face 28, a closed second end plate 36 is arranged which frames the first filter medium body 12 as well as the second filter medium body 14. A second side band 38, which covers second end face edges 40 of the second filter medium body 14, is completely embedded in the second end plate 36.

A support body 48 in the form of a grid-type outer cage surrounds the second filter medium body 14 at an outer circumferential surface 62. Between the support body 48 and the second filter medium body 14, a nonwoven cover 46 may be arranged.

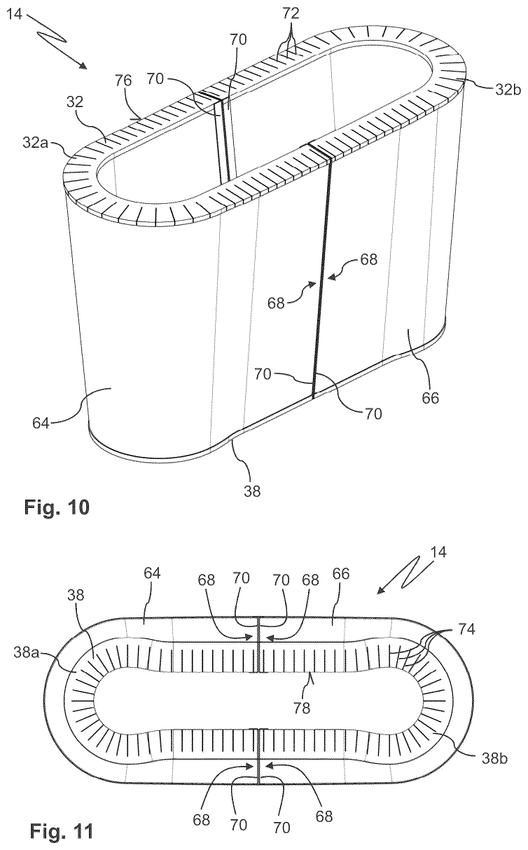

In FIGS. 10 and 11, the second filter medium body 14 of the filter element 60 is illustrated. The second filter medium body 14 is assembled from two filter bellows 64, 66 which are obtained respectively by zigzag folding of the filter medium 18 which contains active carbon and adsorbs harmful gases; compare also FIG. 14. The filter bellows 64, 66 are sealed at their head faces 68 by respective head bands 70 which are glued to the respective filter bellows 64, 66. The head bands 70 may be comprised of a nonwoven material and be angled in an L-shape, wherein a short leg extends at the circumference, here at the inner circumference, at the second filter medium body 14. In order to obtain the annularly closed second filter medium body 14, the filter bellows 64, 66 are bent and a head band 70 of the filter bellows 64 is glued flat to the head band 70 of the filter bellows 66, respectively. In this way, the two filter bellows 64, 66 are air-tightly connected at their head faces 68 to a head face of the other filter bellows 64, 66, respectively.

In a corresponding manner, the second filter medium bodies 14 of the filter elements 10 or 42 may also be assembled of a plurality of filter bellows. It is understood that the second filter medium bodies 14 of the filter elements 10, 42 or 60 may also be obtained from a single filter bellows whose head bands are glued to each other in order to close the filter medium body 14 in circumferential direction. The second filter medium bodies 14 of the filter elements 10, 42 or 60 may also be assembled from more than two filter bellows.

The side bands 32, 38 are here of a two-part configuration, wherein a partial piece 32a, 32b or 38a, 38b of the first or second side band 32, 38 is connected to one of the filter bellows 64, 66, respectively.

The two side bands 32, 38 are provided here with slots 72, 74, respectively. At the first side band 32, the slots 72 extend from an outer edge 76 radially inwardly, compare FIG. 10. At the second side band 38, the slots 74 extend from an inner edge 78 radially outwardly, compare FIG. 11. The slots 72, 74 do not extend completely through the side bands 32, 38 in width direction (radial direction of the filter element 60).

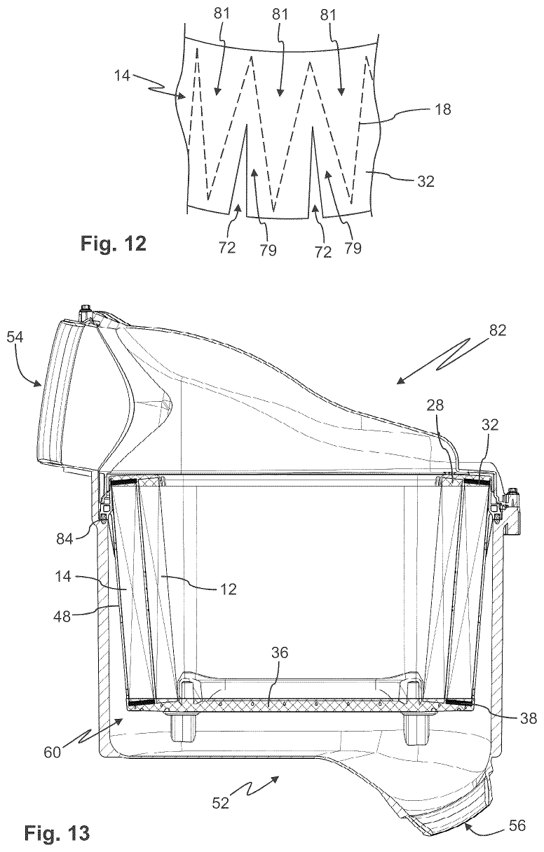

In FIG. 12, in an exemplary fashion it is illustrated for the first side band 32 that the slots 72 extend into an outwardly open fold 79, respectively. In this context, precisely one slot 72 meshes with each fold 79.

In a corresponding manner, the slots 74 of the second side band 38 extend into an inwardly open fold 81, respectively (not illustrated in detail). At the second side band 38, precisely one slot 74 may also mesh with each fold 81.

FIG. 13 shows a filter device 82 with the filter element 60 that is received in a housing 52. An inlet 54 enables entry of air to be filtered into the interior of the filter element 60. Filtered air may be discharged through an outlet 56 from the outer side of the filter element 60. In this embodiment, the filter element 60 contacts with the seal 84 provided at the support body 48 seal-tightly to the housing 52 in order to separate the inlet 54 from the outlet 56. Between the seal 84 and the first end plate 28, the support body 48 is closed in order to force a flow first through the first filter medium body 12 and subsequently through the second filter medium body 14.

FIG. 15 shows a fuel cell 86. The fuel cell 86 comprises an anode 88, a cathode 90, and an electrolyte 92 arranged therebetween. The anode 88 and the cathode 90 each may adjoin outwardly a gas diffusion layer 93. The anode 88 and the cathode 90 may be received between lateral parts 94, 96 of a bipolar plate 98. Hydrogen from a hydrogen inlet 100 may be guided through the lateral part 94 of the bipolar plate 98 to the anode 88. Through the lateral part 96 of the bipolar plate 98, oxygen or air containing oxygen may be guided from an air inlet 102 to the cathode 90. Between the air inlet 102 and the cathode 88, a filter device with a filter element arranged in the housing 52 is provided. The filter element may be one of the above described filter elements 10, 42 or 60; the filter device may be correspondingly one of the above described filter devices 50 or 82. The filter element 10, 42, 60 functions thus as a cathode air filter. Water produced in the fuel cell 86 may be discharged through a water outlet 104. Electrical connections of the fuel cell 86 are not illustrated in detail.

In summary, the invention concerns a two-stage filter element with an inner and an outer filter medium body which may be flowed through serially. The inner filter medium body is arranged in an interior of the outer filter medium body. At least one of the filter medium bodies comprises a folded filter medium, for example containing active carbon, which is covered at the end face by a side band. The side band is continuously embedded in circumferential direction at least with a radial subregion in an end plate which seals the other filter medium body at the end face. The end plate may also seal the folded filter medium body with the side band, wherein the side band may be embedded completely in the end plate. The side band may comprise slots in the region which is embedded in the end plate.

### REFERENCE CHARACTERS

filter element 10
first filter medium body 12
second filter medium body 14
longitudinal axis 16
filter medium 18
layer containing active carbon particles 20
filter paper layer 22
first end face 24
second end face 26
first end plate 28
central opening 30
first side band 32
partial pieces 32a, 32b of the first side band 32
first end face edges 34
second end plate 36
second side band 38
partial pieces 38a, 38b of the second side band 38
second end face edges 40
filter element 42
circumferential surface 44
nonwoven cover 46
support body 48
filter device 50
housing 52
inlet 54
outlet 56
seal bead 58
filter element 60
circumferential surface 62
filter bellows 64, 66
head faces 68
head bands 70
slots 72, 74
outer edge 76
inner edge 78
folds 79, 81
filter device 82
seal 84
fuel cell 86
anode 88
cathode 90
electrolyte 92
gas diffusion layer 93
lateral parts 94, 96
bipolar plate 98
hydrogen inlet 100
air inlet 102
water outlet 104

That which is claimed is:

1. A filter element comprising:
a first filter medium body and a second filter medium body, wherein one of the first and the second filter medium bodies is arranged inside of the other one of the first and the second filter medium bodies, and wherein the first and the second filter medium bodies are configured to be flowed through sequentially;
a first end plate arranged at a first end face of the filter element;
wherein at least the second filter medium body comprises a folded filter medium comprising end face edges at the first end face;
a first side band sealing the end face edges of the folded filter medium of the second filter medium body at the first end face, wherein the first side band is embedded at least partially in the first end plate.

2. The filter element according to claim 1, wherein the first side band projects in a radial direction of the filter element past the folded filter medium of the second filter medium body.

3. The filter element according to claim 1, wherein only a radial subregion of the first side band is embedded in the first end plate.

4. The filter element according to claim 1, wherein the first side band is completely embedded in the first end plate.

5. The filter element according to claim 1, wherein the second filter medium body with the first side band is arranged in a radial direction of the filter element inside of the first filter medium body.

6. The filter element according to claim 1, wherein the second filter medium body with the first side band externally surrounds the first filter medium body.

7. The filter element according to claim 1, wherein the second filter medium body comprises a folded filter bellows comprising two head faces sealed by a head band, respectively, and wherein the second filter medium body comprises an annular shape.

8. The filter element according to claim 1, wherein the second filter medium body comprises at least two filter bellows each comprising head faces sealed by a head band, respectively, wherein the at least two filter bellows adjoin each other in a circumferential direction and are joined to each other at the head bands into an annular shape of the second filter medium body.

9. The filter element according to claim 1, wherein the filter element tapers in an axial direction of the filter element.

10. The filter element according to claim 1, wherein the first side band comprises slots extending into folds of the second filter medium body.

11. The filter element according to claim 9, wherein, at least in a subregion of the second filter medium body, a slot extends into each one of a plurality of folds of the subregion.

12. The filter element according to claim 9, wherein, across the entire circumference of the second filter medium body, a slot extends into a corresponding fold.

13. The filter element according to claim 1, further comprising a second end plate arranged at a second end face of the filter element, wherein the folded filter medium of the second filter medium body comprises end face edges at the second end face, wherein the end face edges of the folded filter medium of the second filter medium body at the second end face are sealed by a second side band, and wherein the second side band is embedded at least partially in the second end plate.

14. The filter element according to claim 13, wherein the first side band comprises slots extending into folds of the second filter medium body and wherein the second side band comprises slots extending into the folds of the second filter medium body.

15. The filter element according to claim 14, wherein the slots of the first side band begin at an inner edge of the first side band and the slots of the second side band begin at an outer edge of the second side band, or wherein the slots of the second side band begin at an inner edge of the second side band and the slots of the first side band begin at an outer edge of the first side band.

16. The filter element according to claim 1, wherein the folded filter medium of the second filter medium body contains active carbon.

17. The filter element according to claim 1, further comprising a nonwoven cover arranged at a circumferential surface of the second filter medium body, and wherein the circumferential surface faces away from the first filter medium body.

18. The filter element according to claim 1, further comprising a support body arranged at a circumferential surface of the second filter medium body, and wherein the circumferential surface faces away from the first filter medium body.

19. The filter element according to claim 1, wherein the filter element is a cathode air filter of a fuel cell.

20. A fuel cell comprising:
an anode and a cathode;
an electrolyte arranged between the anode and the cathode;
the filter element according to claim 1 configured to guide air to the cathode.
